(19) United States
(12) Patent Application Publication
(10) Pub. No.: US 2014/0019215 A1
(43) Pub. Date: Jan. 16, 2014

(54) SYSTEM FOR ASSESSING PROCEDURE COMPLIANCE LEVEL OF HUMAN OPERATORS IN NUCLEAR POWER PLANTS AND METHOD THEREOF

(71) Applicants: KOREA ATOMIC ENERGY RESEARCH INSTITUTE, Daejeon (KR); KOREA HYDRO & NUCLEAR POWER CO., LTD., Gyeongju-si (KR)

(72) Inventors: Won Dea JUNG, Daejeon (KR); Yo Chan KIM, Daejeon (KR); Jin Kyun PARK, Daejeon (KR)

(73) Assignees: KOREA HYDRO & NUCLEAR POWER CO., LTD., Gyeongju-si (KR); KOREA ATOMIC ENERGY RESEARCH INSTITUTE, Daejeon (KR)

(21) Appl. No.: 13/790,790

(22) Filed: Mar. 8, 2013

(30) Foreign Application Priority Data
Jul. 11, 2012 (KR) 10-2012-0075780
Feb. 4, 2013 (KR) 10-2013-0012361

(51) Int. Cl. G06Q 10/06

(52) U.S. Cl. CPC G06Q 10/06398
USPC 705/7.42

(57) ABSTRACT

Disclosed are a system for assessing the procedure compliance level of a human operator in a nuclear power plant, which quantitatively detects if the human operator complies with a standard procedure written in an emergency procedure guideline for the nuclear power plant, and a method thereof. The system includes a first recognizing unit attached to each of human operators, a second recognizing unit that is mounted on each of nuclear power equipments and able to make communication with the first recognizing unit, a database storing information of a standard procedure to be performed by the human operator with respect to the nuclear power equipment, and a server that is able to make communication with the second recognizing unit, and assesses the standard procedure stored in the database and an actual procedure performed by the human operator, which is received from the second recognizing unit.

### BACKGROUND OF THE INVENTION

1. Field of the Invention

The present invention relates to a system for assessing the procedure compliance level of a human operator in a nuclear power plant and a method thereof. In more particular, the present invention relates to a system for assessing the procedure compliance level of a human operator in a nuclear power plant, capable of quantitatively detecting if the human operator complies with a standard procedure written in an emergency procedure guideline for the nuclear power plant, and a method thereof.

2. Description of the Related Art

Human operators (operators) of nuclear power plant facilities have coped with an emergency situation or an abnormal situation in compliance with an emergency procedure guideline.

For example, following patent document 1 (Korean Patent Registration No. 10-0681487 (issued on Feb. 5, 2007)). discloses a technology relating to the optimum evaluation system for safety analysis, capable of simulating an accidental phenomenon, which may occur in a nuclear power plant system, by normalizing the analysis method so that the analysis method can be analyzed and evaluated in the unit of a procedure through the quantization and the standardization thereof, capable of exactly simulating a thermal hydraulic phenomenon of the nuclear power plant system for the analysis method actually applicable to the safety analysis of the nuclear power plant, and capable of ensuring a proper safety margin in various virtual accidents.

However, even if the optimum evaluation system for safety analysis is constructed, the operators may not take actions according to a procedural sequence due to various dynamic situations of the nuclear power plant, the habits of the operators, and the ambiguity of the emergency procedure guideline.

### SUMMARY OF THE INVENTION

If the operators do not comply with the standard procedure written in the emergency procedure guideline, unexpected damages may additionally occur. Accordingly, it is preferred that the operators comply with the standard procedure if possible. However, there is not provided a unit to detect the compliance level with the standard procedure by the operators.

The present invention has been made to solve the problems occurring in the related art, and an object of the present invention is to provide a system for assessing the procedure compliance level of a human operator in a nuclear power plant, capable of quantitatively detecting the procedure compliance level of the human operator for the standard procedure written in an emergency procedure guideline when an emergency situation occurs in the nuclear power plant, and a method thereof.

Another object of the present invention is to provide a system for assessing the procedure compliance level of a human operator in a nuclear power plant, capable of automatically assessing the behavior of the human operator by an analyzer that analyzes the behavior history of each human operator, and a method thereof.

In order to accomplish the above objects, according to one aspect of the present invention, there is provided a system for assessing a procedure compliance level of a human operator in a nuclear power plant. The system includes a first recognizing unit attached to each of human operators, a second recognizing unit that is mounted on each of nuclear power equipments and able to make communication with the first recognizing unit, a database storing information of a standard procedure to be performed by the human operator with respect to the nuclear power equipment, and a server that is able to make communication with the second recognizing unit, and assesses the standard procedure stored in the database and an actual procedure performed by the human operator, which is received from the second recognizing unit.

According to another aspect of the present invention, there is provided a method of assessing a procedure compliance level of a human operator in a nuclear power plant. The method includes (a) recording information of an actual procedure performed by each of human operators and information of each of nuclear power equipments, (b) determining a progressing process of the actual procedure, which is performed with respect to each nuclear power equipment by the human operator in step (a), in a progressing process determining unit, (c) deducing a similarity between a standard procedure stored in a database and the actual procedure, which is determined in step (b), in a similarity calculating unit, and (d) deducing a procedure compliance level of the human operator in a procedure compliance level determining unit based on the similarity which is deduced in step (c).

According to still another aspect of the present invention, there is provided a computer-readable recoding medium recording a program to execute the method of assessing the procedure compliance level of the human operator in the nuclear power plant.

As described above, in the system for assessing the procedure compliance level of the human operator in the nuclear power plant and the method thereof according to the present invention, as the procedure compliance level with the standard procedure for the procedure progressing is calculated, the procedure compliance level with an emergency procedure guideline by a specific operator can be detected as a quantitative index.

Further, in the system for assessing the procedure compliance level of the human operator in the nuclear power plant and the method thereof according to the present invention, the procedure compliance level can be used as a quantitative index for the complexity and the improvement of a job.

Additionally, in the system for assessing the procedure compliance level of the human operator in the nuclear power plant and the method thereof according to the present invention, different procedures and different operating cultures can be mutually compared and analyzed based on procedure progressing histories thereof.

Further, in the system for assessing the procedure compliance level of the human operator in the nuclear power plant and the method thereof according to the present invention, the procedure compliance level can be utilized as a reference affecting the performance of the operator when evaluating human performance and human reliability.

### BRIEF DESCRIPTION OF THE DRAWINGS

FIG. 1 is a block diagram showing the structure of a system for assessing the procedure compliance level of a human operator in a nuclear power plant according to the present invention;

FIG. 2 is a block diagram showing the structure of a database of FIG. 1;

FIG. 3 is a block diagram showing the structure of a server of FIG. 1;

FIG. 4 is a flowchart to explain a method of assessing the procedure compliance level of the human operator in the nuclear power plant according to the present invention; and

FIG. 5 is a view showing the process of assessing the procedure compliance level of the human operator when an emergency situation occurs in the nuclear power plant according to the present invention.

### DETAILED DESCRIPTION OF THE INVENTION

The above object, other objects, and novel features of the present invention will be more clearly comprehended by those skilled in the art with reference to the following description and accompanying drawings.

Hereinafter, the configuration of the present invention will be described with reference to accompanying drawings.

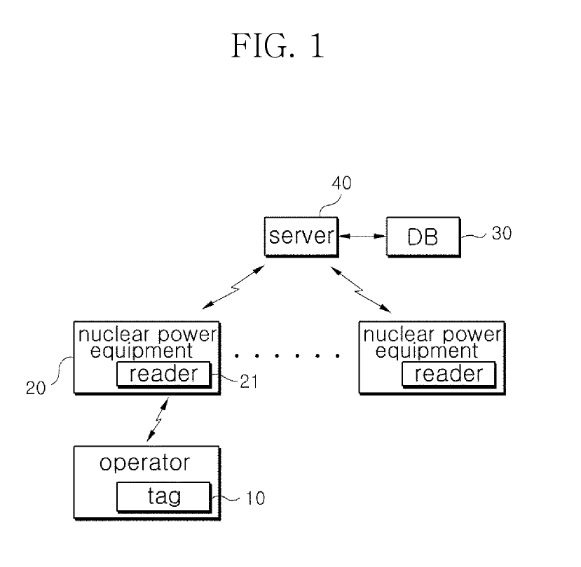

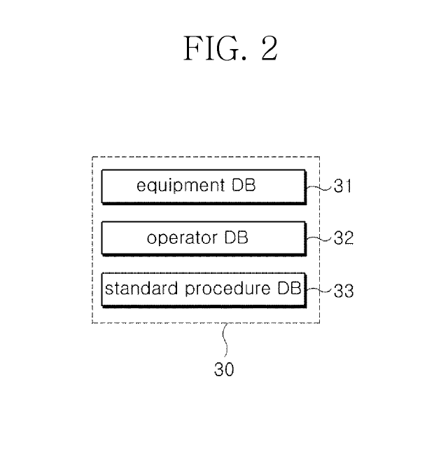

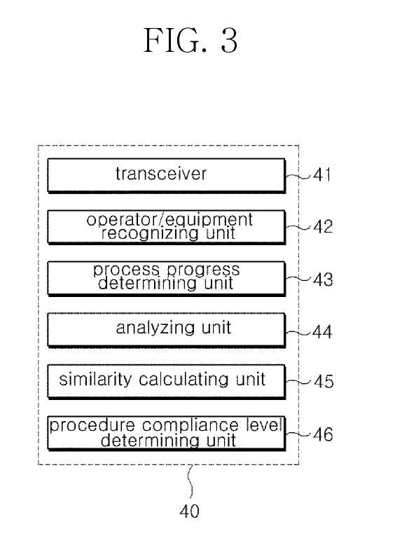

FIG. 1 is a block diagram showing the structure of a system for assessing the procedure compliance level of a human operator in a nuclear power plant according to the present invention, FIG. 2 is a block diagram showing the structure of a database of FIG. 1, and FIG. 3 is a block diagram showing the structure of a server of FIG. 1.

As shown in FIG. 1, a system for assessing the procedure compliance level of a human operator in a nuclear power plant according to the present invention includes a first recognizing unit 10 attached to human operators (operators) who actually operates nuclear power equipments, a second recognizing unit 21 individually mounted on each nuclear power equipment 20 to wirelessly make communication with the first recognizing unit 10, a database 30 to store information about the standard procedure to be followed by each operator, and a server 40 that is able to make communication with the second recognizing unit 21 through a wired/wireless scheme, and assesses the standard procedure stored in the database 30 and an actual procedure performed by each operator according to the second recognizing unit 21.

For example, the first recognizing unit 10 includes a tag attached to the operator, and the second recognizing unit 21 includes a reader to recognize the tag, but the present invention is not limited thereto.

The database 30 is a typical storage device, and constructed based on the database construction theory (or an ontology DB construction theory) while taking into consideration the access to the information of each nuclear power equipment 20 in a nuclear power plant, and the facilitation and the efficiency of the search for the information. As shown in FIG. 2, the database 30 includes an equipment database 31 to store the information of each nuclear power equipment, an operator database 31 to store the information of each operator, and a standard procedure database 33 to store the information about the standard procedure.

The server 40 is connected with a network to provide a service to determine the procedure compliance level with the emergency procedure guideline, which is stored in the database 30, by each operator based on the actual procedure performed by the operator when the emergency situation occurs in the nuclear power plant. The server 40 may serve as a kind of a web-server or a web-service server. For example, the server 40 shows the results processed by a device of an operator (not shown) on a web-page, or receives necessary input data through the web-page. The web-page includes driving software, such as a web-application, to execute a specific work, in addition to a simple text, images, and multimedia. In addition, the server 40 may be constructed to provide the interface with an application (or software) installed in a smart phone, or a table PC.

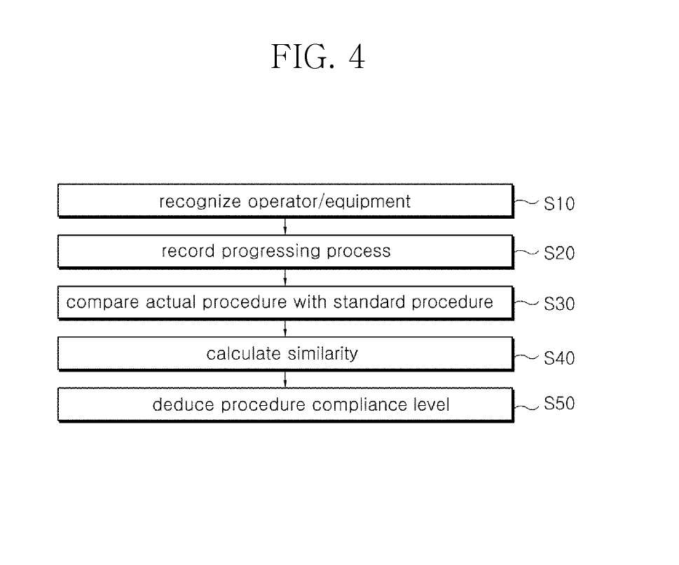

To this end, as shown in FIG. 4, the server 40 includes a transceiver 41 to make communication with the second recognizing unit 21 through a wired/wireless scheme, an operator/equipment recognizing unit 42 to recognize operators and nuclear power equipment 20 via the transceiver 41, a progressing process determining unit 43 to determine the progressing processes of actual procedures performed by operators with respect to the nuclear power equipment 20, an analyzing unit 44 to analyze the actual procedure determined in the progressing process determining unit 43, a similarity calculating unit 45 to calculate the similarity between the actual procedure and the standard procedure, which is determined in the progressing process determining unit 43, and a procedure compliance level determining unit 46 to determine the procedure compliance level with the standard procedure by each operator based on the similarity calculated in the similarity calculating unit 45.

In addition, although the above description has been made in that the database 30 is separately provided from the server 40, the present invention is not limited thereto. In other words, the database 30 may be embedded in the server 40.

As described above, according to the system for assessing the procedure compliance level of the human operator in the nuclear power plant according to the present invention, automatically, the behavior of each operator can be numerically assessed based on the behavior history of the operator

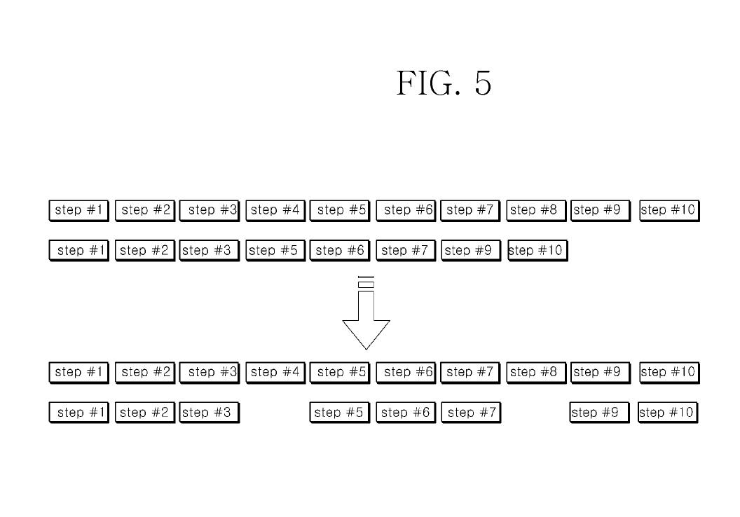

Hereinafter, the method of assessing the procedure compliance level of the operator through the structures shown in FIGS. 1 to 3 in the nuclear power plant will be described with reference to FIGS. 4 and 5.

FIG. 4 is a flowchart to explain a method of assessing the procedure compliance level of the operator in the nuclear power plant according to the present invention. FIG. 5 is a view showing the process of assessing the procedure compliance level of the operator when an emergency situation occurs in the nuclear power plant according to the present invention.

As shown in FIG. 4, the method of assessing the procedure compliance level of the operator in the nuclear power plant according to the present invention includes a step S10 of recording the information of the actual procedure of each operator and the information of each nuclear power equipment, a step S20 of determining the progressing process of the actual procedure, which is performed for each nuclear power equipment 20 by each operator, through the progressing process determining unit 43, a step S30 of comparing the progressing process of the actual procedure with the progressing process of the standard procedure in the analyzing unit 44 by sequentially arranging the progressing process of the actual procedure and the progressing process of the standard procedure, a step S40 of deducing the similarity between the standard procedure stored in the database 30 and the actual procedure determined in the step S30 in the similarity calculating unit 45, and a step S50 of deducing the procedure compliance level of each operator in the procedure compliance level determining unit 46 based on the similarity deduced in the step S40.

In other words, according to the method of assessing the procedure compliance level of the present invention, when an emergency situation occurs in the nuclear power plant, after detecting the actual procedure performed by each operator for the nuclear power equipment, the matching degree between the actual procedure and the standard procedure according to the emergency procedure guideline, that is, the procedure compliance level is quantitatively determined.

Hereinafter, the method of assessing the procedure compliance level under the emergency situation in the nuclear power plant will be described in more detail.

First, the standard procedure according to the emergency procedure guideline is stored in the standard procedure database 33 of the database 30, and the progressing procedure of the actual procedure of an operator is stored in the server 40 that stores data values to be differentially assigned depending on when each step of the standard procedure matches with each step of the actual procedure performed by the operator and do no mismatch with each step of the actual procedure.

The step S10 serves as one example function of a program allowing an analyzer, who analyzes the behavior history of the operator, to assess the behavior of the operator, so that the analyzer collects the behavior history of the operator and stores the behavior history in the progressing process determining unit 43 of the server 40 through the transceiver 41.

However, the present invention is not limited thereto. For example, the system shown in FIG. 1 may be utilized to recognize each operator and each nuclear power equipment 20 through the first and second recognizing units 10 and 21 in step S10. In other words, the reader mounted on each nuclear power equipment 20 may read the tag attached to each operator to detect the progressing process of the actual procedure of the operator, and the server 40 may record therein the progressing process of the actual procedure of the operator through the wired/wireless communication with the reader attached to each nuclear power equipment 20.

In detail, when the emergency situation occurs in the nuclear power pants, there are the standard procedures that must be performed by operators. The standard procedures are stored in the standard procedure database 33 in the form of the emergency procedure guideline. The server 40 stores the standard procedures according to the emergency procedure guideline, and stores data values differentially assigned depending on when steps of an actual procedure, which are performed by each operator under an emergency situation, match with steps of the standard procedure, and mismatch with the steps of the standard procedure in which the data values are previously received in the server 40 from the database 30.

As described above, the steps of the progressing processes of the actual procedures performed by the operators are input into the server 40 that manages various data values and the steps of the standard procedure, so that a specific data value is assigned to each step of each actual procedure.

The step S30 is to sequentially arrange the steps of the progressing process of the actual procedure, which are input through the transceiver 41, in the analyzing unit 44 of the server 40 and the steps of the standard procedure in such a manner that the steps of the actual procedure correspond to the steps of the standard progress.

According to the step S30, the analyzing unit 44 sequentially arranges the steps of the progressing processes of both the actual procedure and the standard procedure.

In other words, as shown in FIG. 5, on the assumption that the standard procedure has the first step to the tenth step, the first step to the tenth step of the standard procedure are sequentially arranged in a horizontal direction. Next, the progressing process of the actual procedure is provided in the row different from that of the standard procedure. If the operator sequentially carries out the actual procedure from the first step to the tenth step as written in the standard procedure, the first step to the tenth step may be arranged in the horizontal direction. However, as shown in FIG. 5, if the progressing process of the actual procedure of the operator has the first step, the second step, the third step, the fifth step, the sixth step, the seventh step, the ninth step, and the tenth step, remaining steps other than the fourth and eighth steps are sequentially arranged.

In addition, the analyzing unit 44 arranges the mutually-matching steps, which are selected among the steps of the progressing process of the actual procedure and the steps of the progressing process of the standard procedure, in the same column, and processes the mismatching steps, which are selected among the steps of the progressing process of the actual procedure and the steps of the progressing process of the standard procedure, as blanks.

In other words, as shown in FIG. 5, the steps, which have a matching relationship among the steps constituting the standard procedure and the steps constituting the actual procedure actually performed by the operator, are the first to third steps, the fifth to seventh steps, the ninth step, and the tenth step. Accordingly, the first to tenth steps of the standard procedure are sequentially arranged in the first to tenth columns, the first step, the second step, the third step, the fifth step, the sixth step, the seventh step, the ninth step, and the tenth step of the actual procedure are arranged in the first, second, third, fifth, sixth, seventh, ninth, and tenth columns of the row right under the row for the steps of the standard procedure, respectively, and the positions for the fourth and eighth steps, which do not constitute the actual procedure, are processed as blanks.

In the step S40, the similarity calculating unit 45 calculates the similarity of steps by receiving the data values, which are differentially assigned depending on when the steps of the progressing process of the actual procedure match with the steps of the progressing process of the standard procedure and mismatch with the steps of the progressing process of the standard procedure, from the analyzing unit 44.

In more detail, in the step S40, the similarity of the steps is calculated as the sum of the data values, which are differentially assigned in the matching case of the steps and the mismatching case of the steps, by applying the Smith-Waterman algorithm to the steps of the progressing process of the actual procedure and the steps of the progressing process of the standard procedure.

In other words, the above description is simply expressed as an equation, “the similarity of the steps=smith_waterman (actual procedure, standard procedure)”. The similarity of the steps refers to a value calculated through the Smith-Waterman algorithm. According to the Smith-Waterman algorithm, components are arranged at ranks different from each other, and mutually-similar components of two ranks are arranged in the same column, so that the similar positions of the two ranks can be easily detected and the similarity of the two ranks can be measured.

As described above, the similarity calculating unit 45 differentially assigns the data values depending on when the steps of the actual procedure performed by the operator match with the steps of the standard procedure, and mismatch with the steps of the standard procedure. In other words, the similarity calculating unit 45 assigns a data value as 1 when each step of the progressing process of the actual procedure match with the related step of the progressing process of the standard procedure, and assigned as 0 when the step of the progressing process of the actual procedure mismatches with the step of the progressing process of the standard procedure. In this case, the blanks shown in FIG. 5 are assigned with the data values of 0, and remaining parts are assigned with the data values of 1. Accordingly, the similarity value of the steps measured in step S40 is 8.

The step S50 is to deduce data of the procedure compliance level used to determine the similarity degree of the actual procedure with respect to the standard procedure by comparing the similarity of the steps calculated in the step 40 with the similarity obtained when the actual procedure is performed identically to the standard procedure.

In other words, the step S50 includes a step of calculating the standard similarity by applying the Smith-Waterman algorithm to the steps of the progressing process when the operator performs the progressing process of the actual procedure identically to the progressing process of the standard procedure. The standard similarity value found in the calculating step is obtained through the Smith-Waterman algorithm as described above. In other words, when the Smith-Waterman algorithm is applied based on “standard similarity=Smith_Waterman (standard procedure, standard procedure)”, various standard similarity values may be determined due to the characteristic of the Smith-Waterman algorithm.

The data of the procedure compliance level are deduced by dividing the similarity of the steps measured in the step S40 by the standard similarity.

Since the similarity of the steps measured in the step S40 is 8, and the standard similarity obtained in the step S50 is 10, the procedure compliance level of the progressing procedure becomes 8/10 (=0.8). The increase of the procedure compliance level with the progressing process represents that the operator more thoroughly complies with the standard procedure according to the emergency procedure guideline. The decrease of the procedure compliance level with the progressing process represents that the operator less thoroughly complies with the standard procedure according to the emergency procedure guideline.

The present invention is not limited to the above-described embodiment, and may be variously modified by those skilled in the art to which the present invention pertains without departing from the spirit of the present invention and the modification falls within the scope of the present invention.

What is claimed is:

1. A system for assessing a procedure compliance level of a human operator in a nuclear power plant, the system comprising:
a first recognizing unit attached to each of human operators;
a second recognizing unit that is mounted on each of nuclear power equipments and able to make communication with the first recognizing unit;
a database storing information of a standard procedure to be performed by the human operator with respect to the nuclear power equipment; and
a server that is able to make communication with the second recognizing unit, and assesses the standard procedure stored in the database and an actual procedure performed by the human operator, which is received from the second recognizing unit.

2. The system of claim 1, wherein the server includes:
a progressing process determining unit determining a progressing process of the actual procedure which is performed by the human operator with respect to each nuclear power equipment;
a similarity calculating unit calculating a similarity between the actual procedure and the standard procedure, which is determined in the progressing process determining unit; and
a procedure compliance level determining unit determining the procedure compliance level with the standard procedure by the human operator based on the similarity calculated in the similarity calculating unit.

3. The system of claim 2, wherein the first recognizing unit includes a tag attached to the human operator, and the second recognizing unit includes a reader to recognize the tag.

4. The system of claim 2, wherein the server further includes:
a transceiver making communication with the second recognizing unit through a wired/wireless scheme; and
an operator/equipment recognizing unit recognizing the human operator and the nuclear power equipment via the transceiver.

5. The system of claim 4, wherein the server further includes an analyzing unit analyzing the actual procedure determined in the progressing process determining unit.

6. The system of claim 1, wherein the database includes:
an equipment database storing information of each nuclear power equipment;
an operator database storing information of each human operator; and
a standard procedure database storing information of the standard procedure.

7. The system of claim 2, wherein the procedure compliance level with the standard procedure is determined by determining a compliance level with an emergency procedure guideline in relation to the actual procedure which is performed by the human operator with respect to each nuclear power equipment when an emergency situation occurs in the nuclear power plant.

8. A method of assessing a procedure compliance level of a human operator in a nuclear power plant, the method comprising:
(a) recording information of an actual procedure performed by each of human operators and information of each of nuclear power equipments;
(b) determining a progressing process of the actual procedure, which is performed with respect to each nuclear power equipment by the human operator in step (a), in a progressing process determining unit;
(c) deducing a similarity between a standard procedure stored in a database and the actual procedure, which is determined in step (b), in a similarity calculating unit; and
(d) deducing a procedure compliance level of the human operator in a procedure compliance level determining unit based on the similarity of step (c).

9. The method of claim 8, wherein the actual procedure is individually performed by the human operator with respect to the individual nuclear power equipment when an emergency situation occurs in the nuclear power plant, and the standard procedure is provided in an emergency procedure guideline stored in the database.

10. The method of claim 8, wherein the step (b) includes sequentially-arranging a progressing process of the actual procedure and a progressing process of the standard procedure in an analyzing unit.

11. The method of claim 10, wherein the step (a) includes:
detecting the progressing process of the actual procedure performed by each human operator by reading a tag attached to the human operator in a reader mounted on each nuclear power equipment; and
recording the progressing process of the actual procedure performed by the human operator in the server through wireless communication with the reader mounted on the nuclear power equipment.

12. The method of claim 10, wherein the step (b) further includes:
arranging mutually-matching steps, which are selected among steps of the progressing process of the actual procedure and steps of the progressing process of the standard procedure, in a same column; and
processing mismatching steps, which are selected among steps of the progressing process of the actual procedure and steps of the progressing process of the standard procedure, as blanks.

13. The method of claim 10, wherein, in the step (c), the similarity is calculated as a sum of data values, which are differentially assigned depending on when steps of the progressing process of the actual procedure match with steps of the progressing process of the standard procedure and when the steps of the progressing process of the actual procedure mismatch with the steps of the progressing process of the standard procedure, by applying a Smith-Waterman algorithm to the steps of the progressing process of the actual procedure and the steps of the progressing process of the standard procedure.

14. The method of claim 10, wherein step (d) includes:
calculating a standard similarity by applying a Smith-Waterman algorithm to steps of the progressing process of the actual procedure when the progressing process of the actual procedure is performed identically to the progressing process of the standard procedure; and
deducing data of the procedure compliance level by dividing the similarity measured in the step (c) by the standard similarity.

15. The method of claim 10, wherein the step (a) is performed according to the information of each nuclear power equipment stored in an equipment database and information of each human operator stored in an operator database.

16. A computer-readable recoding medium recording a program to execute the method of assessing the procedure compliance level of the human operator in the nuclear power plant, which is claimed according to claim 8.
